(19) United States
(12) Patent Application Publication
(10) Pub. No.: US 2017/0322796 A1
(43) Pub. Date: Nov. 9, 2017

(54) DEVICE AND METHOD FOR UPDATING FIRMWARE AND FIRMWARE UPDATE SYSTEM

(71) Applicant: Electronics and Telecommunications Research Institute, Daejeon (KR)

(72) Inventors: Dae-Won KIM, Daejeon (KR); Young-Sae KIM, Daejeon (KR); Yong-Hyuk MOON, Daejeon (KR); Seung-Yong YOON, Daejeon (KR); Jin-Hee HAN, Daejeon (KR); Jae-Deok LIM, Sejong (KR); Jeong-Nyeo KIM, Daejeon (KR); Yong-Sung JEON, Daejeon (KR)

(21) Appl. No.: 15/365,513

(22) Filed: Nov. 30, 2016

(30) Foreign Application Priority Data
May 9, 2016 (KR) 10-2016-0056362

(51) Int. Cl. G06F 9/445; G06F 11/14; G06F 9/44

(52) U.S. Cl. CPC G06F 8/65; G06F 11/1451; G06F 11/1469; G06F 9/4406; G06F 11/1433; G06F 2201/805

(57) ABSTRACT

Disclosed herein are a device and method for updating firmware and a firmware update system. The device for updating firmware include an update manager for receiving delta information about the latest version of firmware from an update server by checking information about a version of firmware installed in a terminal device and for updating the firmware installed in the terminal device using the delta information, and a bootloader for restoring the updated firmware using previously stored backup information when the updated firmware is not normally launched or when an error occurs during the update of the firmware.

### CROSS REFERENCE TO RELATED APPLICATION

This application claims the benefit of Korean Patent Application No. 10-2016-0056362, filed May 9, 2016, which is hereby incorporated by reference in its entirety into this application.

### BACKGROUND OF THE INVENTION

### 1. Technical Field

The present invention relates to a device and method for updating firmware and to a firmware update system.

### 2. Description of the Related Art

As Internet of Things (IoT) technology for connecting all devices via wired and wireless networks has come to receive attention, lightweight devices for IoT are actively being developed.

Because lightweight devices are configured with minimal resources for operating only core functions, the resources are limited and the functions are simple. Accordingly, a lightweight device uses a single compiled image file that includes the functions of an Operating System (OS), applications, and the like therein. Generally, this image file is called ‘firmware’.

In the process of booting a device, firmware data are sequentially processed in the memory. Such firmware is updated for various purposes, such as the improvement of the performance of a device, the expansion of functions of a device, and the like. However, the update of firmware may fail due to an error or the like during the update process. In this case, a firmware recovery function is required.

Recovery of firmware may be processed in such a way that the current firmware, the update of which has failed, is restored to the firmware that was released when the device was launched, or to the previously used firmware, which was executing normally. In the existing technology for the recovery of firmware, because normal firmware in the form of uncompressed or compressed files is stored in advance for recovery, additional storage having a size that is equal to or greater than the size of the uncompressed or compressed normal firmware is required. However, the additional storage may result in increased expenses, and may be a burden on the development and sale of price-sensitive lightweight devices.

### Documents of Related Art

(Patent Document 1) Korean Patent Application Publication No. 10-2013-0138635.

### SUMMARY OF THE INVENTION

An object of the present invention is to provide a device and method for updating firmware and a firmware update system in which, when firmware of a terminal device having limited memory resources, such as a lightweight device or the like, is updated, the update is processed in delta information units and in which only firmware data corresponding to delta information are backed up and used to restore firmware, whereby memory resources may be more effectively used.

The technical objects of the present invention are not limited to the above-mentioned technical object, and other technical objects that have not been mentioned will be clearly understood by those skilled in the art from the following description.

In order to accomplish the above object, a firmware update device according to the present invention includes an update manager for receiving delta information about a latest version of firmware from an update server by checking information about a version of firmware installed in a terminal device and for updating the firmware installed in the terminal device using the delta information; and a bootloader for restoring the firmware using previously stored backup information when the updated firmware is not normally launched or when an error occurs while updating the firmware.

Here, the update manager may create backup information for data stored at a location corresponding to the delta information, among data of the firmware installed in the terminal device, and stores the backup information.

The update server may store one or more pieces of delta information about the firmware, and the update manager may sequentially perform an update in response to each of the pieces of delta information stored in the update server.

The update manager may calculate an amount of available space in memory and store the backup information in the available space in the memory when the amount of the available space is greater than a size of data included in the delta information.

When the firmware is updated, the update manager may check a location and size of data to be backed up based on the delta information, among the data of the firmware installed in the terminal device.

When the firmware is updated, the update manager may check a location and size of data to be updated based on the delta information, among the data of the firmware installed in the terminal device, and may update the data corresponding to the checked location and size.

The update manager may check whether or not the updated firmware is normally launched, and store a result of checking in a bootloader environment variable area of memory, and the bootloader may read information from the bootloader environment variable area of the memory when the terminal device is booted, and may thereby check whether it is necessary to restore the updated firmware.

When the firmware is restored, the bootloader may load the backup information, which has been stored in available space, check data to be restored, a location of the data, a size of the data, and a number of pieces of the data, among the data of the firmware to be restored, and restore the checked number of pieces of data, which correspond to the checked location and size.

The delta information may include data that differ between the latest version of the firmware and the version of the firmware installed in the terminal device, and a location and a size of the corresponding data.

The delta information may be created in a form of a data unit, a size of which is one byte.

Meanwhile, in order to accomplish the above object, a method for updating firmware according to the present invention includes receiving delta information about a latest version of firmware from an update server by checking information about a version of firmware installed in a terminal device; creating backup information for data, stored at a location corresponding to the delta information, among data of the firmware installed in the terminal device, and storing the backup information; updating the firmware installed in the terminal device using the delta information; and when the updated firmware is not normally launched or when an error occurs during the update of the firmware, restoring the corresponding firmware using the previously stored backup information.

Also, the method according to the present invention may further include, when an update of the firmware based on the received delta information is completed, receiving next delta information from the update server.

Also, the method according to the present invention may further include, before creating the backup information, calculating an amount of available space in memory, and comparing the amount of available space in the memory with a size of data included in the delta information.

Creating the backup information and storing the backup information may be performed when the amount of available space in the memory is greater than the size of the data included in the delta information.

Also, the method according to the present invention may further include checking a location and size of data to be backed up based on the delta information, among the data of the firmware installed in the terminal device, before creating the backup information and storing the backup information.

Updating the firmware may include checking a location and size of data to be updated based on the delta information, among the data of the firmware installed in the terminal device, and updating the data corresponding to the checked location and size.

Restoring the firmware may include loading the backup information, which has been stored in available space; checking data to be restored, a location of the data, a size of the data, and a number of pieces of the data, among data of the firmware to be restored; and restoring the checked number of pieces of data, which correspond to the checked location and size.

Meanwhile, in order to accomplish the above object, a firmware update system according to the present invention includes an update server for storing and managing firmware in respective versions, which is to be provided to a terminal device, and creating and providing delta information about a latest version of firmware when an update to the latest version of the firmware is performed; and a firmware update device for receiving the delta information about the latest version of the firmware from the update server, updating firmware installed in the terminal device using the delta information, and restoring the updated firmware using backup information for data stored at a location corresponding to the delta information, among data of the firmware installed in the terminal device, when the updated firmware is not normally launched or when an error occurs during the update of the firmware.

The firmware update device may check a location and size of data to be backed up based on the delta information, among data of the firmware installed in the terminal device, and may store the backup information in available space in memory when an amount of the available space in the memory is greater than a size of data included in the delta information.

When the firmware is updated, the firmware update device may check a location and size of data to be updated based on the delta information, among data of the firmware installed in the terminal device, and may update the data corresponding to the checked location and size.

When the firmware is restored, the firmware update device may load the backup information, which has been stored in the available space, check the data to be updated, a location of the data, a size of the data, and a number of pieces of the data, and update the checked number of pieces of the data, which correspond to the checked location and size.

The update server may create delta information including data that differ between the latest version of the firmware and the version of the firmware installed in the terminal device, and a location and a size of the corresponding data.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view that shows the configuration of a firmware update system according to the present invention;

FIG. 2 is a view that shows the configuration of a firmware update device according to the present invention;

FIG. 3 is a view that shows an embodiment that is referred to when describing a firmware update process according to the present invention;

FIG. 4 is a view that shows an embodiment that is referred to when describing a firmware recovery process according to the present invention;

FIG. 5 and FIG. 6 are views that show the flow of operation of a firmware update method according to the present invention; and

FIG. 7 is a view that shows a computing system to which a device according to the present invention is applied.

### DESCRIPTION OF THE PREFERRED EMBODIMENTS

Hereinafter, embodiments of the present invention will be described in detail with reference to the accompanying drawings. It should be noted that the same reference numerals are used to designate the same or similar elements throughout the drawings. In the following description of the present invention, detailed descriptions of known functions and configurations which are deemed to make the gist of the present invention obscure will be omitted.

Various terms, such as “first”, “second”, “A”, “B”, “(a)”, “(b)”, etc., can be used to differentiate one component from the other, but the substances, order or sequence of the components are not limited by the terms. Unless defined differently, all terms used here, including technical or scientific terms, have the same meanings as terms generally understood by those skilled in the art to which the present invention pertains. Terms identical to those defined in generally used dictionaries should be interpreted as having meanings identical to contextual meanings of the related art, and are not to be interpreted as having ideal or excessively formal meanings unless they are definitely defined in the present specification.

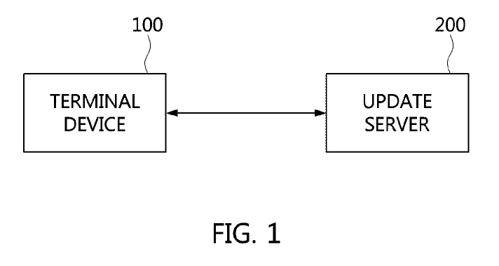

FIG. 1 is a view that shows the configuration of a firmware update system according to the present invention.

As illustrated in FIG. 1, the firmware update system according to the present invention may include a terminal device 100 and an update server 200.

The terminal device 100 is a lightweight device that is capable of communicating with the update server 200. The terminal device 100 may be provided with firmware from the update server 200, and may install and execute the firmware.

Meanwhile, the update server 200 serves to store and manage firmware to be provided to the terminal device 100. Here, the update server 200 may manage firmware in respective versions. When a terminal device 100 requests that firmware be downloaded, the update server 200 may extract a corresponding version of the firmware and provide it to the corresponding terminal device 100.

Also, when the latest version of firmware is stored, the update server 200 may create an update file for the corresponding firmware. In this case, the update server 200 may inform the terminal device 100, in which the previous version of the firmware is installed, of information about the update of the firmware.

Meanwhile, the update server 200 may create update information of firmware in response to a request from a terminal device 100. In this case, the update server 200 checks versions of the requested firmware and creates update information when there is a firmware version that is more recent than the version of the firmware installed in the terminal device 100.

Then, the update server 200 provides the created update information to the terminal device 100 in order to update the firmware of the terminal device 100. Here, the update information may be delta information, which is created by extracting only the difference between the latest version of firmware and the firmware currently installed in the terminal device 100.

A delta file may be information represents a difference between two firmwares of which versions are different. Information of a delta file may be divided into one or more delta information. That is to say, delta information may be information which represents a part of a difference between two firmware of which versions are different. Or, a combination of information which one or more delta information represent may correspond to information which a delta file represents.

For example, delta information may be information for data changed between the latest version of firmware and the firmware currently installed in the terminal device 100.

Delta information may include changed data and information about the location and size of the changed data. A firmware may be composed in a form of a data unit, a size of which is a byte. So, for the delta information the location of the change data may indicate a position in bytes.

The delta information may be created in a form of a data unit, a size of which is a predefined unit. For example, the delta information may be created in a form of a data unit, a size of which is one byte.

Here, there may be multiple pieces of delta information for respective changed data units. Hereinafter, each of the pieces of delta information is referred to as “unit delta information”.

In other words, the terminal device 100 is provided with unit delta information from the update server 200 and updates data stored at the location corresponding to the received unit delta information, among data of the installed firmware. When the update of the data based on the unit delta information, provided from the update server 200, is completed, the next piece of unit delta information is received from the update server 200, and data stored at the location corresponding to the received unit delta information is updated in the firmware.

That is to say, when a plurality of delta information are required for updating of the firmware, the terminal device 100 may obtain only one delta information from the update server 200 at a moment, and perform the update of the firmware partly using the obtained delta information. After the obtained delta information is used for the partial update, the terminal device may delete the used delta information, or set a memory or a storage which the used delta information occupies as an available memory or an available storage. And, after the obtained delta information was deleted, the terminal device 100 may obtain next delta information from the update server 200.

By a way to update the firmware partly using one or more delta information continuously, a low-performance also can perform an update of a firmware or a recovery of a firmware. And, by the way to update the firmware, an update of a firmware or a recovery of a firmware can be performed in a case that an available memory or an available storage are as small as one delta information.

Here, the terminal device 100 performs an update in the state in which the previous version of firmware, specifically, the data stored at the location corresponding to the unit delta information, is backed up, depending on the amount of available space in flash memory 141, and if an error occurs when launching the updated firmware, the terminal device 100 may perform a recovery operation using the backup of the corresponding firmware.

Meanwhile, a firmware update device for controlling an update and recovery of the firmware installed in the terminal device 100 may be implemented in the terminal device 100. Here, the firmware update device may be integrated to internal control units of the terminal device 100, or may be implemented as a separate unit and connected with the control units of the terminal device 100 through a connection means.

Alternatively, the firmware update device may be implemented outside the terminal device 100, and may be connected with the terminal device 100 using an additional connection means.

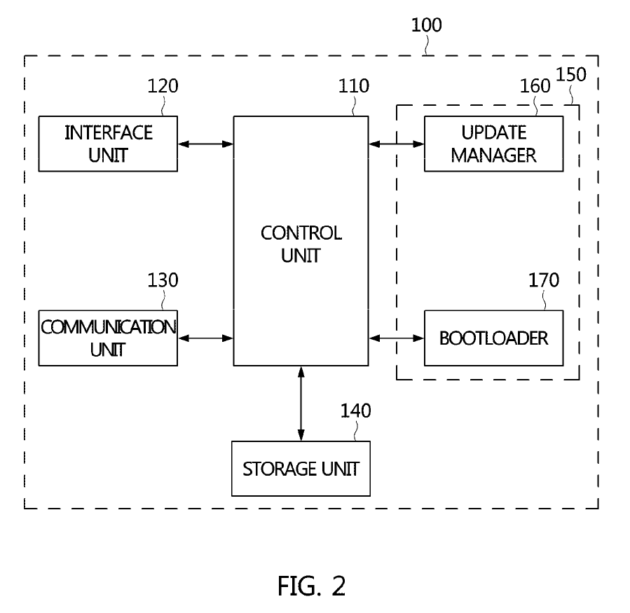

The components of a firmware update device will be described with reference to FIG. 2.

FIG. 2 is a view that shows the components of a firmware update device according to the present invention.

As illustrated in FIG. 2, the firmware update device may include a control unit 110, an interface unit 120, a communication unit 130, a storage unit 140, and a signal processing unit 150. Here, the control unit 110 may process signals delivered between the units of the firmware update device.

First, the interface unit 120 may include an input means through which predetermined control instructions may be input by a user. The input means may be a key button, but the input means may be realized as any means through which control instructions may be input by a user.

Also the interface unit 120 may include an output means for outputting the state and result of the operation of the firmware update device. The output means may include a display on which information, such as the state and result of the operation of the firmware update device, is displayed, and may include a speaker from which the result may be output in voice.

Here, the display may include a Liquid Crystal Display (LCD), an Organic Light-Emitting Diode (OLED), a flexible display, and the like. Of course, the display may be variously implemented according to an embodiment.

The communication unit 130 may include a communication module for providing a communication interface between the firmware update device and the update server 200. The communication module may include a module for wireless Internet access or a module for short-range communication.

The storage unit 140 may store data, programs and the like required for the operation of the firmware update device. Here, the storage unit 140 may include a storage medium such as flash memory 141 and Random Access Memory (RAM) 145. The flash memory 141 may store one or more pieces of firmware downloaded from the update server 200, and may store a bootloader environment variable, which is used when the terminal device 100 is booted.

The signal processing unit 150 may download firmware from the update server 200 and install the firmware, and may perform an update by checking the version of the installed firmware. Also, when the firmware is updated, the signal processing unit 150 determines whether it is necessary to restore the firmware, and may restore the firmware. The signal processing unit 150 performs an update in response to each piece of unit delta information provided from the update server 200.

To this end, the signal processing unit 150 may include an update manager 160 and a bootloader 170. Here, the update manager 160 and the bootloader 170 may be executed in the RAM 145 by the control unit 110.

The update manager 160 executed by the control unit 110 may check information about the version of firmware by accessing the update server 200 through the communication unit 130. Here, when information about an update to the latest version is received from the update server 200, the update manager 160 may check information about the latest version of the firmware. Alternatively, without reception of the update information, the update manager 160 may periodically check information about the version of firmware registered in the update server 200.

Here, when checking the version of firmware, if it is determined that firmware that is more recent than the currently installed version is present in the update server 200, the update manager 160 may receive delta information, which is update information, from the update server 200.

Here, the delta information refers to information about data that differ between the current version of firmware and the latest version of the firmware, and may include the differing data and information about the location and size of the corresponding data. Here, the firmware may be configured with data in individual bytes.

The update manager 160 may detect the number of pieces of unit delta information present in the update server 200 and sequentially perform an update in response to each of the pieces of unit delta information.

For example, when some data in the first version of the firmware installed in the terminal device 100 are ‘ABCDE’ and the data corresponding thereto in the latest version of the firmware are ‘ABCFG’, the fourth byte ‘D’ and the fifth byte ‘E’, included in the first version of the firmware, differ from the fourth byte ‘F’ and the fifth byte ‘G’, included in the latest version of the firmware. Accordingly, unit delta information may include the location information ‘4’ and the size information ‘1 (byte)’ so as to correspond to the fourth byte ‘F’ within the latest version of the firmware, and may include the location information ‘5’ and the size information ‘1 (byte)’ so as to correspond to the fifth byte ‘G’.

First, the update manager 160 may receive the total size of the delta information from the update server 200. Here, the update manager 160 calculates the amount of available space in the flash memory 141. The update manager 160 compares the amount of available space with the total size of the delta information, and may enable a backup function when the amount of available space is greater than the total size of the delta information.

When the backup function is enabled, the update manager 160 receives unit delta information from the update server 200. Then, the update manager 160 searches the data of the current version of the firmware installed in the terminal device 100 for the data stored at the location corresponding to the location of the data within the received delta information, and stores a backup of the found data in the available space in the flash memory 141. In this case, the update manager 160 may store the number of pieces of data to be backed up and the location and size thereof in the available space, along with the data.

For example, if the received unit delta information includes the fourth byte and the fifth byte of the firmware, the update manager 160 may search the current version of the firmware for the fourth and fifth bytes and store a backup of the found data, the number of the pieces of data, ‘2’, the location information ‘4, 5’, and the size information ‘2 (bytes)’, in the available space in the flash memory 141.

After storing the information about the current version of the firmware, the update manager 160 updates the data at the corresponding location in the current version of the firmware using the received unit delta information.

For example, the update manager 160 updates the fourth and fifth bytes of the current version of the firmware using the fourth byte ‘F’ and the fifth byte ‘G’, included in the received unit delta information.

When some data of the firmware have been updated using the received unit delta information, the update manager 160 may receive the next unit delta information from the update server 200. Here, the update manager 160 sequentially receives the unit delta information and updates the data stored at the location corresponding to the received unit delta information, among data of the firmware.

Before performing an update on the data based on unit delta information, the update manager 160 stores a backup of the data stored at the corresponding location and information thereabout in the available space of the flash memory 141.

If a backup function is in a disabled state, the update manager 160 may immediately update the firmware without storing the backup of the current version of the firmware.

When the update of the firmware corresponding to the entire delta information has been completed, the terminal device 100 is rebooted, and when the terminal device 100 is rebooted, the update manager 160 may check whether the updated firmware is normally launched, whether an error occurs, and the like and store the result in the bootloader environment variable area of the flash memory 141. The information stored in the bootloader environment variable area is loaded by the bootloader 170 when a terminal device is booted, and may be used to check whether it is necessary to restore the corresponding firmware.

If it is determined that it is necessary to restore the firmware based on the information loaded from the bootloader environment variable area when the terminal device 100 is booted, the bootloader 170 restores the data, which include an error in the firmware installed in the terminal device 100, to the data of the previous version.

When restoring the updated firmware data to the previous version, the bootloader 170 loads a backup after checking whether the backup of the corresponding data is stored in the flash memory 141. Here, the bootloader 170 restores the updated firmware to the previous version of the firmware using the loaded backup.

When restoration of the updated firmware data to the previous version has been completed, the terminal device 100 is rebooted, and when the terminal device 100 is rebooted, the update manager 160 may check whether the restored firmware is normally launched and store the result in the bootloader environment variable area of the flash memory 141. The information stored in the bootloader environment variable area is loaded by the bootloader 170 when a terminal device is booted, and may be used to check whether it is necessary to restore the corresponding firmware.

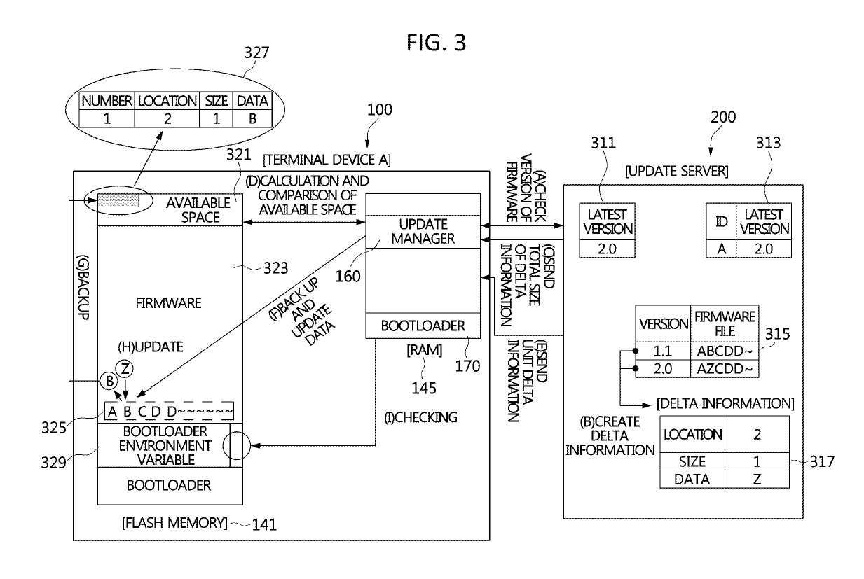

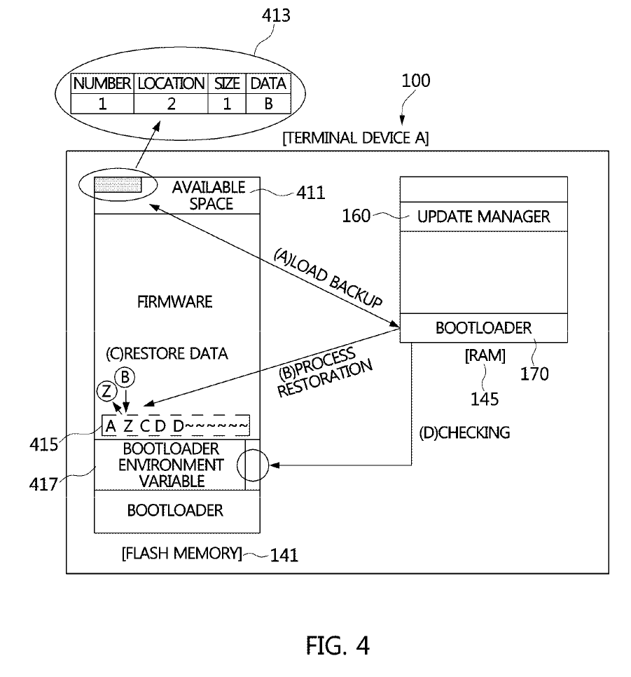

An embodiment of an update of the firmware installed in the terminal device 100 and the operation for recovery of the previous firmware will be described in detail with reference to FIG. 3 and FIG. 4.

FIG. 3 is a view that shows an embodiment that is referred to when describing a firmware update process according to the present invention.

Referring to FIG. 3, the update manager 160 and the bootloader 170 may be executed in the RAM 145. The update manager 160 checks information about the version of firmware by accessing the update server 200 as operation (a). Here, the update server 200 may check whether the firmware currently installed in the terminal device 100 is the latest version by comparing the current version information 313 of the firmware installed in the terminal device 100 with the most recent version information 311.

For example, when the version of the firmware installed in the terminal device 100 is 1.1 and the latest version is 2.0, the update server 200 may extract and compare the files 315 of the corresponding versions of the firmware. The update server 200 compares the firmware file in version 1.1 with the firmware file in version 2.0, creates and stores one or more pieces of unit delta information 317 for the data that differ between the two firmware files as operation (b), and sends the created unit delta information to the update manager 160 of the terminal device 100.

Here, before sending the unit delta information, the update server 200 sends information about the total size of the delta information to the update manager 160 of the terminal device 100 as operation (c), and the update manager 160 checks available space in the flash memory as operation (d) based on the information about the total size of the delta information, and may enable a backup function when sufficient space for backing up information is guaranteed.

Then, after sending a piece of unit delta information to the update manager 160 of the terminal device 100, when it receives information about the completion of the update, the update server 200 may send the next piece of unit delta information to the update manager 160 of the terminal device 100. Through the above-mentioned process, the update server 200 may sequentially send all of the pieces of unit delta information to the update manager 160.

The unit delta information 317, created in operation (b), may include the data ‘Z’ in the firmware file in version 2.0, which differ from that in the firmware file in version 1.1, the location information ‘2’ corresponding to the location of the data ‘Z’, and the size information ‘1 (byte)’.

When it receives the unit delta information 317 from the update server 200 as operation (e), the update manager 160 backs up and updates the firmware data stored in the flash memory 141, the size and location of which are the same as those in the received unit delta information, that is, one byte of data starting from the second byte, which is ‘B’, as operation (f). Specifically, the update manager 160 creates information 327 to be backed up for ‘B’, among the firmware data 325 stored in the flash memory 141, which are ‘ABCDD . . . ’, as operation (g), and stores the created information 327 in the available space in the flash memory. Here, the information 327 may include the number of pieces of data, the location of the data, the size of the data, and the corresponding data.

When the data ‘B’ is backed up, the update manager 160 updates the firmware data 325 as operation (h) based on the received unit delta information 317. Here, among the firmware data 325 stored in the flash memory 141, the update manager 160 updates the one byte of the data, starting from the second byte, to data ‘Z’.

The update manager 160 may check whether the updated firmware is normally launched and store the result in the bootloader environment variable area 329 of the flash memory 141. Accordingly, when the terminal device is booted, the bootloader 170 may check the result of the update as operation (i) based on the information stored in the bootloader environment variable area 329.

When the update based on the received delta information 317 is completed, the update manager receives the next unit delta information from the update server 200 and sequentially performs the operations shown in FIG. 3, thereby updating the data at the location corresponding to the received delta information.

FIG. 4 is a view that shows an embodiment that is referred to when describing a firmware recovery process according to the present invention.

Referring to FIG. 4, after the firmware of a terminal device 100 is updated, if the updated firmware is not launched, or if an error occurs, the terminal device is rebooted and a bootloader 170 is executed in the RAM 145. In this case, the bootloader 170 restores the updated firmware to the previous version of the firmware. Here, the terminal device may be manually rebooted through the manipulation by a user.

When the updated firmware is restored to the previous version of firmware, the bootloader 170 loads a backup 413 as operation (a) after checking whether the backup 413 is stored in the available space 411 in the flash memory 141. Here, the bootloader 170 restores the updated firmware to the previous version of the firmware using the loaded backup 413 as operations (b) and (c).

For example, the bootloader 170 restores ‘Z’, which is the one byte starting from the second byte in the updated firmware data 415, ‘AZCDD . . . ’, to ‘B’ based on the backup 413.

When the updated firmware data 415, which are ‘AZCDD . . . ’, are restored to the previous version of firmware data ‘ABCDD . . . ’, the terminal device 100 is rebooted. When the terminal device 100 is rebooted, the bootloader 170 may load the information from the bootloader environment variable area of the flash memory 141, and may thereby check whether it is necessary to again restore the firmware as operation (d).

The flow of operation of a device according to the present invention, configured as described above, will be described below.

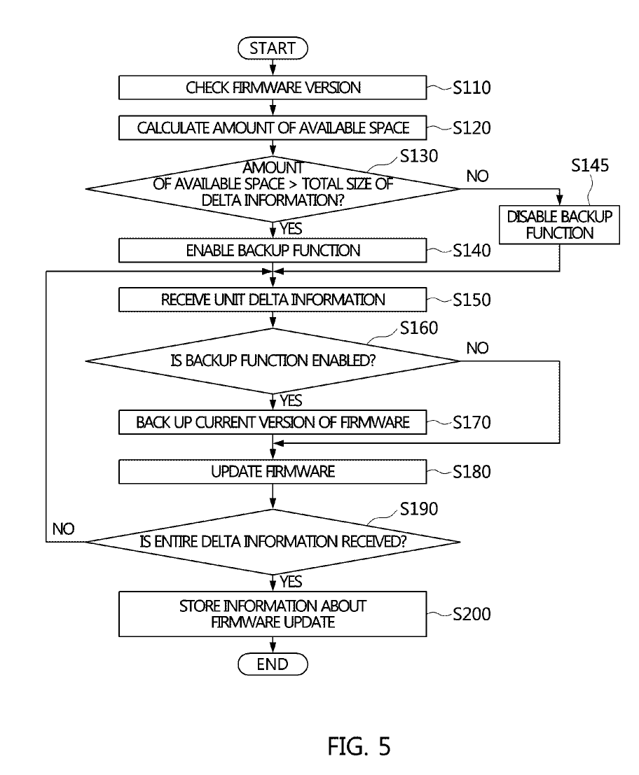

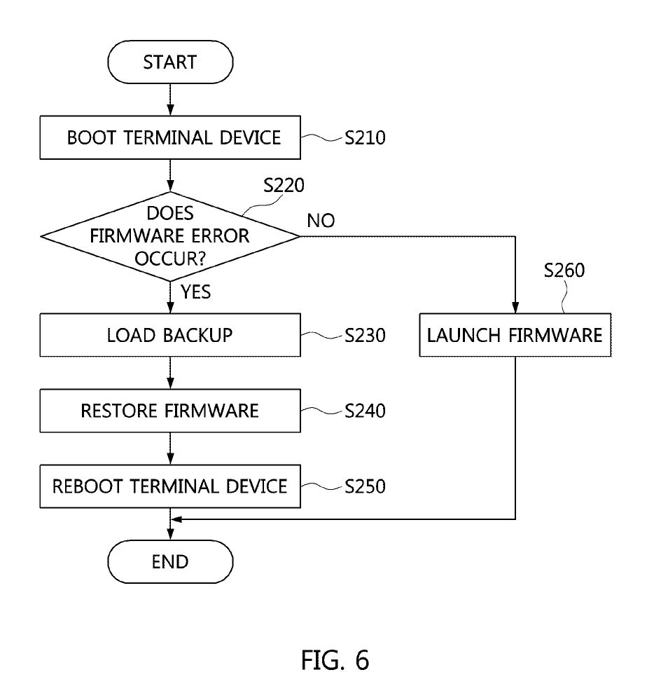

FIG. 5 and FIG. 6 are views that show the flow of operation of a firmware update method according to the present invention.

As illustrated in FIG. 5, a firmware update device checks information about versions of firmware by accessing an update server at step S110. Here, if firmware that is more recent than the firmware installed in a terminal device is present in the update server, the firmware update device receives information about the total size of the delta information from the update server and calculates the amount of available space in the flash memory at step S120 based on the received information.

The firmware update device calculates the amount of available space in the flash memory and checks whether the amount of the available space is greater than the total size of the delta information. If it is determined at step S130 that the amount of available space is greater than the total size of the delta information, the firmware update device enables a backup function of the flash memory at step S140, but if not, the firmware update device disables the backup function at step S145.

Subsequently, the firmware update device may receive unit delta information from the update server at step S150. If it is determined at step S160 that the backup function is enabled through the process at step S140, the firmware update device stores, in the available space at step S170, a backup of the data stored at the location corresponding to the received delta information, among the data of the current version of the firmware stored in the flash memory.

At step S170, the firmware update device extracts data, the location and size of which correspond to the location and size specified in the received unit delta information, from the current version of the firmware stored in the flash memory, creates a backup from the extracted data, and stores the created backup in the available space in the flash memory.

If the backup function is disabled through the process at step S145, the process at step S170 may be skipped.

Subsequently, the firmware update device updates the firmware stored in the flash memory using the received unit delta information at step S180.

After the process at step S180, the firmware update device checks whether all the pieces of unit delta information have been received from the update server. If it is determined at step S190 that not all of the pieces of unit delta information have been received, the firmware update device receives the next piece of unit delta information at step S150, and then performs the processes of steps S160 to S180.

The processes of steps S150 to S180 are repeatedly performed until all the pieces of unit delta information stored in the update server have been received.

When it is determined at step S190 that all the pieces of unit delta information have been received, the firmware update device stores information about the update of the corresponding firmware at step S200 and terminates the process of updating firmware.

When the update of firmware is completed, the terminal device may be rebooted.

As illustrated in FIG. 6, if an error occurs in the updated firmware at steps S210 and S220 when the terminal device is booted, the firmware update device loads the backup of the previous version of the firmware, which was stored in the available space at step S170 of FIG. 5, at step S230.

Here, the firmware update device restores the updated firmware to the previous version at step S240 using the backup loaded at step S230.

When the restoration to the previous version at step S240 is completed, the firmware update device reboots the terminal device at step S250, and thereby launches the firmware restored to the previous version.

Meanwhile, if there is no error in the updated firmware when the terminal device is booted, the terminal device executes the firmware at step S260.

The firmware update device according to the present embodiment, operated as described above, may be implemented as an independent hardware device. Meanwhile, the firmware update device according to the present embodiment may be at least one processor, and may be operated by being included in another hardware device such as a microprocessor or a general computer system.

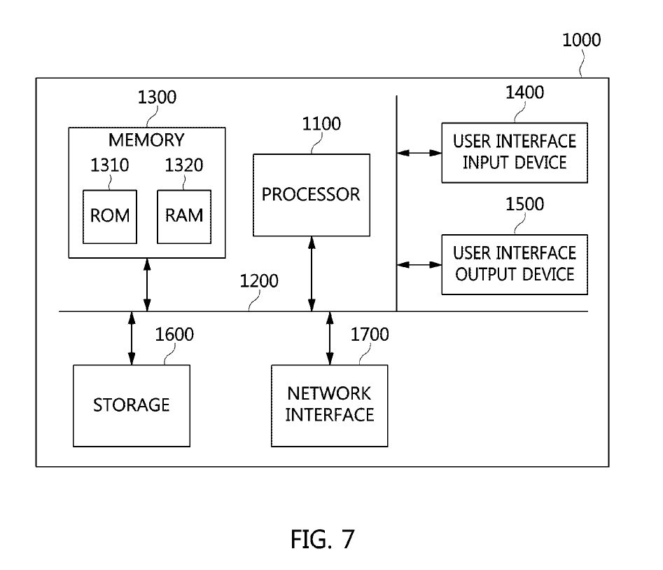

FIG. 7 is a view that shows a computing system to which the device according to the present invention is applied.

Referring to FIG. 7, the computing system 1000 may include at least one processor 1100, memory 1300, a user interface input device 1400, a user interface output device 1500, storage 1600 and a network interface 1700, which are connected with each other via a bus 1200.

The processor 110 may be a central processing unit (CPU) or a semiconductor device for processing instructions stored in the memory 1300 and/or the storage 1600. The memory 1300 and the storage 1600 may include various types of volatile or nonvolatile storage media. For example, the memory 1300 may include Read Only Memory (ROM) and Random Access Memory (RAM).

Accordingly, the step of performing the method or the step of executing the algorithm that has been described in connection with the embodiments disclosed in the present specification may be implemented as hardware, a software module or a combination thereof, which is executed by the processor 1100. The software module may be stored in the storage media, such as RAM, flash memory, ROM, EPROM, EEPROM, a register, a hard disk, a removable disk, or a CD-ROM, that is, in the memory 1300 and/or the storage 1600. The exemplary storage media are coupled to the processor 1100, and the processor 1100 may read and interpret information stored in the storage media and write information thereto. In another example, the storage media may be integrated with the processor 1100. The processor integrated with the storage media may be stored in an Application-Specific Integrated Circuit (ASIC). The ASIC may be stored in a user terminal. In other examples, the processor and storage media may be stored in a user terminal as separate components.

According to the present invention, when firmware of a terminal device having limited memory resources, such as a lightweight device, is updated, the update is processed in delta information units, and only firmware data corresponding to delta information are backed up and used to restore the firmware, which is advantageous in that memory resources may be effectively used.

The above description merely illustrates the technical spirit of the present invention, and those skilled in the art may make various changes and modifications without departing from the scope of the present invention.

Accordingly, the embodiments, having been disclosed in the present invention, are intended not to limit but to describe the technical spirit of the present invention, and the scope of the technical spirit of the present invention is not limited to the embodiments. The scope of protection of the present invention must be interpreted based on the accompanying claims, and all the technical spirit in the same range as the claims must be interpreted as being included in the scope of rights of the present invention.

What is claimed is:

1. A firmware update device, comprising:
an update manager for receiving delta information about a latest version of firmware from an update server by checking information about a version of firmware installed in a terminal device and for updating the firmware installed in the terminal device using the delta information; and
a bootloader for restoring the firmware using previously stored backup information when the updated firmware is not normally launched or when an error occurs,
wherein the update manager creates backup information for data stored at a location corresponding to the delta information, among data of the firmware installed in the terminal device, and stores the backup information.

2. The firmware update device of claim 1, wherein:
the update server stores one or more pieces of delta information about the firmware; and
the update manager sequentially performs an update in response to each of the pieces of delta information stored in the update server.

3. The firmware update device of claim 1, wherein the update manager calculates an amount of available space in memory and enables a backup function when the amount of available space is greater than a total size of delta information.

4. The firmware update device of claim 1, wherein when the firmware is updated, the update manager checks a location and size of data to be backed up based on the delta information, among the data of the firmware installed in the terminal device.

5. The firmware update device of claim 1, wherein when the firmware is updated, the update manager checks a location and size of data to be updated based on the delta information, among the data of the firmware installed in the terminal device, and updates the data corresponding to the checked location and size.

6. The firmware update device of claim 1, wherein:
the update manager checks whether or not the updated firmware is normally launched, and stores a result of checking in a bootloader environment variable area of memory; and
the bootloader reads information from the bootloader environment variable area of the memory when the terminal device is booted, and thereby checks whether it is necessary to restore the updated firmware.

7. The firmware update device of claim 1, wherein when the firmware is restored, the bootloader loads the backup information, which has been stored in available space, checks data to be restored, a location of the data, a size of the data, and a number of pieces of the data, among the data of the firmware to be restored, and restores the checked number of pieces of data, which correspond to the checked location and size.

8. The firmware update device of claim 1, wherein the delta information includes data that differ between the latest version of the firmware and the version of the firmware installed in the terminal device, and a location and a size of the corresponding data.

9. The firmware update device of claim 1, wherein the delta information is created in a form of a data unit, a size of which is one byte.

10. A method for updating firmware, comprising:
receiving delta information about a latest version of firmware from an update server by checking information about a version of firmware installed in a terminal device;
creating backup information for data, stored at a location corresponding to the delta information, among data of the firmware installed in the terminal device, and storing the backup information;
updating the firmware installed in the terminal device using the delta information; and
when the updated firmware is not normally launched or when an error occurs, restoring the firmware using the previously stored backup information.

11. The method of claim 10, further comprising:
when an update of the firmware based on the received delta information is completed, receiving next delta information from the update server.

12. The method of claim 10, further comprising:
before receiving the delta information,
receiving information about a total size of delta information from the update server;
calculating an amount of available space in memory; and
comparing the amount of available space in the memory with the total size of the delta information.

13. The method of claim 12, wherein creating the backup information and storing the backup information are performed when the amount of available space in the memory is greater than the total size of the delta information.

14. The method of claim 10, further comprising:
before creating the backup information and storing the backup information,
checking a location and size of data to be backed up based on the delta information, among the data of the firmware installed in the terminal device.

15. The method of claim 10, wherein updating the firmware comprises:
checking a location and size of data to be updated based on the delta information, among the data of the firmware installed in the terminal device; and
updating the data corresponding to the checked location and size.

16. The method of claim 10, wherein restoring the firmware comprises:
loading the backup information, which has been stored in available space;
checking data to be restored, a location of the data, a size of the data, and a number of pieces of the data, among data of the firmware to be restored; and
restoring the checked number of pieces of data, which correspond to the checked location and size.

17. A firmware update system, comprising:
an update server for storing and managing firmware in respective versions, which is to be provided to a terminal device, and creating and providing delta information about a latest version of firmware when an update to the latest version of the firmware is performed; and
a firmware update device for receiving the delta information about the latest version of the firmware from the update server, updating firmware installed in the terminal device using the delta information, and restoring the updated firmware using backup information for data stored at a location corresponding to the delta information, among data of the firmware installed in the terminal device, when the updated firmware is not normally launched or when an error occurs.

18. The firmware update system of claim 17, wherein:
the update server stores one or more pieces of delta information about the firmware; and
the firmware update device sequentially performs an update in response to each of the one or more pieces of delta information stored in the update server.

19. The firmware update system of claim 17, wherein the firmware update device checks a location and size of data to be backed up based on the delta information, among data of the firmware installed in the terminal device, and stores the backup information in available space in memory when an amount of available space in the memory is greater than a size of data included in the delta information.

20. The firmware update system of claim 17, wherein when the firmware is updated, the firmware update device checks a location and size of data to be updated based on the delta information, among data of the firmware installed in the terminal device, and updates the data corresponding to the checked location and size.
